(19) United States
(12) Patent Application Publication
(10) Pub. No.: US 2019/0392795 A1
(43) Pub. Date: Dec. 26, 2019

(54) INCREMENTALLY IMPROVED DIATONIC STAFF MUSICAL NOTATION SYSTEM

(71) Applicant: Eugen Tarnow, Fair Lawn, NJ (US)

(72) Inventor: Eugen Tarnow, Fair Lawn, NJ (US)

(21) Appl. No.: 16/447,885

(22) Filed: Jun. 20, 2019

Related U.S. Application Data
(60) Provisional application No. 62/688,681, filed on Jun. 22, 2018.

(51) Int. Cl. G10G 1/02; G09B 15/02; G10G 1/04

(52) U.S. Cl. CPC G10G 1/02; G10G 1/04; G09B 15/026

(57) ABSTRACT

I disclose a system of sheet music notation. It allows for quicker visual identification of the line or line space number on an individual staff and replaces clefs with simpler pitch indicators. It creates an equality between the two upper and lower staves of the grand staff by using a 6+6 staff line combination in which the first notes in both staves are named the same (though different octaves). It allows for an intermediate step between 5+5 and 6+6 notations to help convert those used to the 5+5 notation to the 6+6 notation and vice versa. It allows the number of staff lines to be increase as a music student becomes more advanced. Finally it creates a staff in which each note in a scale is represented just once and same named notes in different octaves are always in the same staff position.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATIONS

This application claims the benefit of U.S. Provisional Application No. 62/688,681 filed Jun. 22, 2018, by the present inventor; the disclosure is hereby incorporated herein by reference.

### PRIOR ART

U.S. Pat. Nos.

| | Kind | | |
|---|---|---|---|
| Pat. or Pub. No. | Code | Issue or Pub. Date | Patentee or Applicant |
| 10,013,961 | B2 | Jul. 3, 2018 | Campbell; Sean |
| 10,002,542 | B2 | Jun. 19, 2018 | Jenkins; Steven |
| 9,947,301 | B2 | Apr. 17, 2018 | Kelsey; Nathan |
| 7,482,525 | B2 | Jan. 27, 2009 | Reverdin; Nathalie |
| 7,253,349 | B2 | Aug. 7, 2007 | Saltsman; Joseph Clay |
| 6,476,303 | B2 | Nov. 5, 2002 | Mutou; Kanpei, Mutou; |
| | | | Ritsuko, Mutou; Seburou |

### Nonpatent Internet Pages

https://www.abdn.ac.uk/mediareleases/release.php?id=1341
https://imslp.org/wiki/My_Ladye_Nevells_Grownde_(Byrd %2C_William)
https://muto-method.com/en/history.html
https://muto-method.com/en/score.html
https://en.wikipedia.org/wiki/Clef
https://en.wikipedia.org/wiki/Colored music notation

The standard diatonic musical staff is a set of five lines that hold musical notes (historically, sometimes there were more or less than five lines). Notes outside the staff are indicated with tiny lines called ledger lines. Notes on these small ledger lines are probably more difficult to read than notes on a regular staff line. To minimize the number of ledger lines, clefs, usually situated close to the middle of the staff, indicate pitches that are in a middle range (tessitura) for the instrument or voice that is using the staff. Before the clefs became ornate, they were simply the name of the note—though without the complete octave designation.

The standard piano grand staff has two staves combined in a continuous fashion with a middle C on a separate ledger line Between the two staves. The two clefs, the G clef in the treble staff and the F clef in the bass staff mark the positions of two notes (G4 and F3) in the two staves accordingly. They are each on the second line counting from the middle, i.e. marking the notes in an anti-parallel (contrarian) manner. The F clef looks a little like an upside down G clef and may have looked even more so in earlier times (see https://en.wikipedia.org/wiki/Clef). This is one of the problems of the grand staff—while music repeats in parallel every octave, the notation system is favoring anti-parallel thinking. This tension is exemplified in the notion of a “middle C”. While it refers to the middle note in the grand staff, many people believe it refers to the “middle” C of the piano. And even in the grand staff it rarely stays in the middle: when the “middle C” is played by the right hand it is moved off the middle towards the treble staff and when it is played by the left hand it is moved off the middle towards the bass staff. Additional ledger lines are often introduced between the staves presumably to keep the right hand notes away from the bass staff and left hand notes away from the treble staff.

Parallel symmetry is introduced with the octava line that indicates that a section of music is to be played one octave above or below the written pitch.

Another problem with the standard clefs is that they are difficult for beginners to understand or draw and their visual reach is limited to the left corner. The ornateness of the clefs may be a symptom of the religious or mystical element in music. While mysticism and religious feelings create great music or allow for awe when listening to it, it is counterproductive in music notation. The ornateness may also serve an exclusionary purpose—making musicians seem more special than they are because they are able to read what seems to be mystical and complex.

Notation in which pitches have particular colors has been tried unsuccessfully because the colors themselves replace the music notation so that when the colors are removed, children cannot read the notes (see, for example, https://en.wikipedia.org/wiki/Colored music notation). Presumably, adults would not want to use colored notation because it detracts attention (the number of colors is usually seven, one for each note, which creates a very distracting display).

The anti-parallel origin of the standard piano grand staff forces the same named notes of different octaves to be shifted in the two staves (see FIG. 1). The C3 in the bass staff is situated between the second and third lines while the C5 in the treble staff is situated between the third and fourth lines. In addition, C6 is situated on a second ledger line above the treble staff, also shifted from the C4 which is situated on the first ledger line. C2 is on the second ledger line down from the bass staff. So there are five Cs and each of them in a different place in the staves. This causes great difficulty for beginners and is an inefficient way to read notes even for professionals: if the brain has to store multiple positions for the same named notes every time there is a change of staff or a change of octave; the notation system is bound to cause a slowdown in the cognitive processes. Of course, if the brain was thinking in an anti-parallel fashion and numbering the lines away from the middle, C3 and C5 are in similar locations as are C4 and C6, but the note below C4 is B3 while the note above C4 is D4—up and down are just not the same. Music octaves, the piano octaves, and the western musical ear all repeat in parallel, not in anti-parallel.

One reason that the current notation has five different places for Cs may be that piano is sometimes taught in an anti-parallel fashion: instead of starting with the same notes in both hands, one sometimes often start with notes surrounding the middle C4 and the left hand plays a B3 and A3 when the right hand plays D4 and E4. Clearly, it would be better to start with the same notes in both hands—especially since keyboards have repeating symmetry.

One would like to see an improved musical notation in which the clefs are easier to understand and have a longer visual reach, and in which same named notes are in the same positions, and in which parallel thinking replaces the anti-parallel tendency of the current notation system, and—this is very important—is very similar to the current diatonic grand staff standard (as opposed to notation systems proposed, for example, in U.S. Pat. Nos. 9,947,301 or 10,002,542 or 10,013,961). This last condition is important for adaption—very few professionals would want to learn a new notation system from scratch. Since it is the professionals who teach the younger generation the professionals have to be satisfied.

Identifying the actual position of a note is difficult if there are many lines, thus the five line staff, for which there is no real reason, may consist of the largest number of lines that is convenient to read.

The composition by William Byrd written in 1591 (the original is at

https://www.abdn.ac.uk/mediareleases/release.php?id=1341
and the translation onto the 5+5 grand staff is at
https://imslp.org/wiki/My_Ladye_Nevells_Grownde_(Byrd%2C_William))
) utilizes a diatonic grand staff of 6+6 lines. However, the first line on his treble staff is a C4 while the first line on his bass staff is a G2—they are not the same named notes (disregarding the octaves). Also, the first line in the treble staff and the last line in the bass staff refer to the same note, the staves overlap and do not obey the principle of continuity.
U.S. Pat. No. 6,476,303, also described at https://muto-method.com/en/score.html under the name “Muto method,” discloses a chromatic, rather than diatonic, notation system. There are no flats and sharps but there are a lot more notes to be displayed. It is very difficult to switch from a diatonic system to a chromatic system and it seems to have had little influence. It also contains strike-through notes that indicate the notes are to be played on the piano black keys. It repeats the note placements—an octave up the notes names are the same on the corresponding lines and spaces. A chromatic notation system has more lines than a diatonic notation system and is therefore more difficult to read. There is no easy way to transform the current standard 5+5 line notation into this chromatic notation. The inventors attempt to solve this by removing lines (two supplementary lines between the base line and the center line are removed after the music is written down) and also having the remaining lines (base line and center line) drawn in two different thicknesses. But to make it possible to read this complex notation without enough lines the inventor adds in ledger lines. Clefs are not needed because the baselines are all understood to represent “Do” and each octave number is indicated between the base lines. Since the standard piano keyboard is diatonic there is a mismatch that the inventor solves by creating a new chromatic keyboard. Thus in the end this is not a practical solution since we need to keep the current standard keyboard design—otherwise all pianos that exist would have to be scrapped. I cannot find any videos of anyone playing the piano with this method and there are questions as how to fast one can play on a chromatic keyboard.
7,253,349 discloses a 6+6 line chromatic notation. There is no easy way to transform the current standard 5+5 line notation into the notation of U.S. Pat. No. 7,253,349.
7,482,525 discloses lines that do not correspond to notes but to the strings on a string instrument and the corresponding line thickness varies continuously according to the thickness of the strings. This continuous thickness change does not help quick identification of the notes but rather helps realize the order of the strings—if you keep the guitar with the thick string on top then you know whether you have to flip the notation in your mind or not.

### BACKGROUND—ADVANTAGES

Accordingly several advantages of one or more aspects are as follows: it improves the conventional diatonic 5+5 grand staff notation system in small steps to make the improvements acceptable to users, to replace the treble and bass clefs with simpler indicators, to allow for quicker visual identification of the line or line space number on an individual staff, to create an equality between the upper and lower staves of the grand staff, to minimize the number of different positions taken up by same named notes, to introduce new music students to a staff with a slowly increasing number of lines.

### SUMMARY

This discloses a cognitively improved music notation system that be implemented in gradual changes of the current notation system. Ornate clefs can be replaced by straightforward pitch notation and they can be extended visually from the left hand corner by changing the line or line space design. Rather than having five different placements of C2-C6, adding a line can limit it to three different placements and adding two lines can limit it to two different placements. Teaching students using a slowly increasing number of lines is also disclosed. Two novel staff systems in which each note has exactly one position is disclosed as well.

The advantages and features of novelty characterizing aspects of the invention are pointed out with particularity in the appended claims. To gain an improved understanding of the advantages and features of novelty, however, reference may be made to the following descriptive matter and accompanying figures that describe and illustrate various configurations and concepts related to the invention.

### DRAWINGS

FIG. 1 shows the standard grand staff in which C notes can be found on second ledger line below the bass staff (C2), between the 2^{nd} and 3^{rd} lines in the bass staff (C3), on the middle ledger line between the staves (C4), in the treble staff between the 3^{rd} and 4th lines (C5) and on the second ledger line above the treble staff (C6).

FIG. 2 shows a grand staff with an extra “helper” line at the bottom of the bass staff. This allows C3 and C5 to both be between the 3^{rd} and 4th lines in the upper and lower staves and C2 and C4 are both on a single ledger line.

FIG. 3 shows a grand staff with an extra “helper” line at the top of the treble staff. C4 and C6 are both on a single ledger line and C5 and C3 are both between lines 3 and 4 in the upper and lower staves, respectively, counting from top to bottom.

FIG. 4 shows a new grand staff with six lines in each staff.

FIG. 5 shows a standard grand staff without clefs but with pitch indicators.

FIG. 6 displays a new grand staff with more than two staves. The lettering indicates the identity of the single ledger lines in between the staves, and this lettering replaces the clefs.

FIG. 7 displays a staff with five lines and the middle line is thicker than the other lines.

FIG. 8 displays a staff with 6 lines in which the middle line space has a grey background.

FIG. 9 displays two staves in which each staff has three lines and two line spaces and two additional positions right above and below the staves

FIG. 10 displays two staves in which each staff has four lines and three line spaces. The positions right above and below the staves are not allowed.

FIG. 11 displays a non-continuous grand staff with the positions of C3 and C5 indicated.

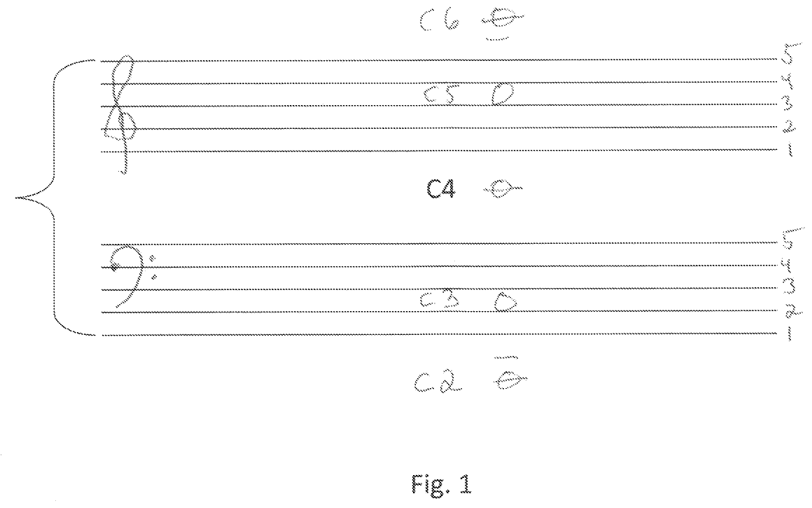

### DEFINITIONS

N+M grand staff: a grand staff consisting of a bass staff with N lines and a treble staff with M lines.
Bass staff: the bass staff in the grand staff, the staff typically utilized by the left hand.
Black keys: A diatonic keyboard instrument is typically consisting of black and white keys in which the white keys correspond to the scale of C major and the black keys are the keys needed to make a chromatic scale.
Combinations of staves: staves that are meant to be played simultaneously by one person. Thus even if orchestra partituras or four hand piano pieces may have two staves with same named notes that are to be played at the same time, they staves are meant to be played by different people.
Diatonic staff: A staff in which each position is taken by a note in a diatonic scale, typically the C major scale.
Distinguishable line: line distinguishable from other line(s) by weight, style (full, dashed, dotted, dash-dotted, double line, etc.) and/or color.
Distinguishable line space: line space distinguishable from other line space(s) by color (for example, shaded) or spacing width; or line weight, style and color of lines defining the space.
Helper line: additional line added to a staff to make same named notes appear on the same line or line space in at least two staves counting the lines in parallel fashion for both staves (down to up, or up to down, for both staves).
Keyboard instrument: a musical instrument with a diatonic keyboard; mechanical or electronic.
Line space: the space between two lines of the same staff.
Musician: refers to the person using the music notation. Can be an instrumentalist or a vocalist and can be a student or a professional.
Pitch indicator: A clef that is a symbol from the American Standard Pitch Notation or other notations that specify both the note name and the octave. Can be on the right hand side or the left hand side of a staff.
Same position: Notes that have the same position in different staves in which the position, on, above or below a line or a ledger line, is counted top to bottom or bottom to top but in the same way for all staves.
Same named note: a note that has the same name (A, B, G) without regard to which octave it is in (so C4 has the same name as C3 etc.).
Staff space: the space between two staves.
Standard piano grand staff: the standard diatonic grand staff consisting of two 5 line staves with a G clef on the second line of the treble staff and an F clef on the fourth line of the bass staff (counting from bottom to top).
Treble staff: the treble staff in the grand staff, the staff typically utilized by the right hand

### DETAILED DESCRIPTION

Certain embodiments of the present invention include, but are not limited to:

### First Embodiment—the Diatonic Grand Staff Helper Line

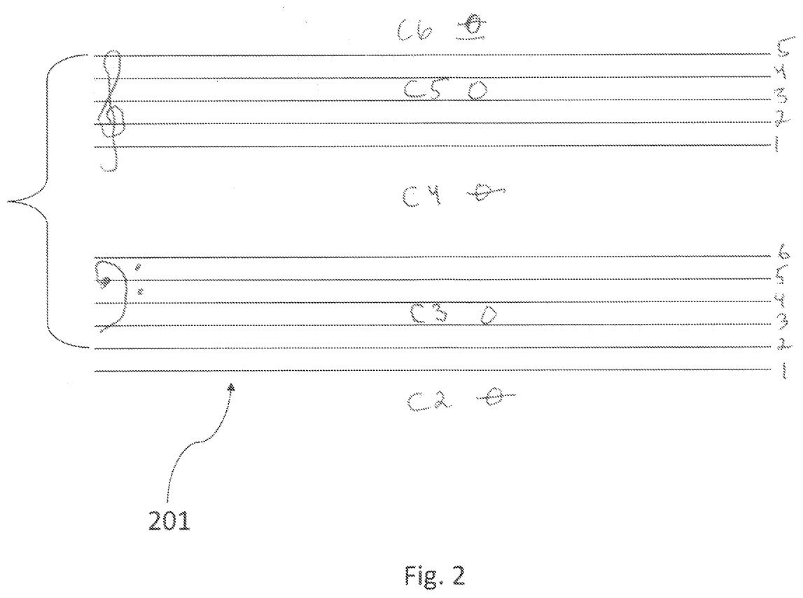

In FIG. 2 is shown a helper line 201 drawn below the bass staff of the diatonic grand staff. This allows C5 and C3 to be placed between the 3^{rd} and 4^{th} lines, counting bottom to up, in the treble and bass staves and C2 and C4 both placed on single ledger lines. Thus rather than five difference C positions there are now only three.

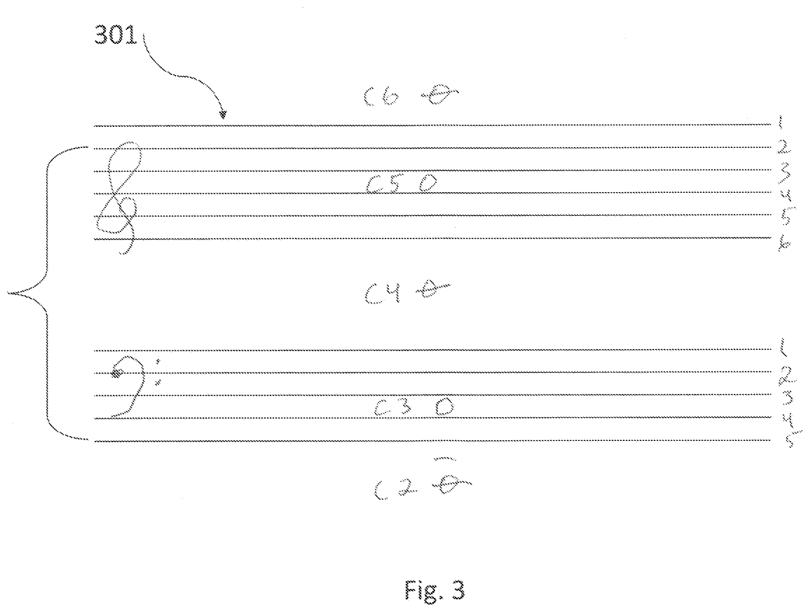

A corresponding helper line 301 may also be drawn above the treble staff of the grand staff (FIG. 3), making C4 and C6 both appear on the first ledger line and, if one this time counts the lines from top to bottom, C5 and C3 both appear between the 3rd and 4^{th} lines in the upper and lower staves. Thus rather than five difference C positions there are now only three.

The helper line(s) can be a distinguishable line.

### Second Embodiment—the 6+6 Diatonic Grand Staff

The standard diatonic scale has seven notes on lines and line spaces. If a note is on a line, the same note in the next octave will be on a line space and vice versa. The best one can do on a system of continuous lines and spaces is to have two different placements of each note. This can be accomplished with the 6+6 diatonic grand staff.

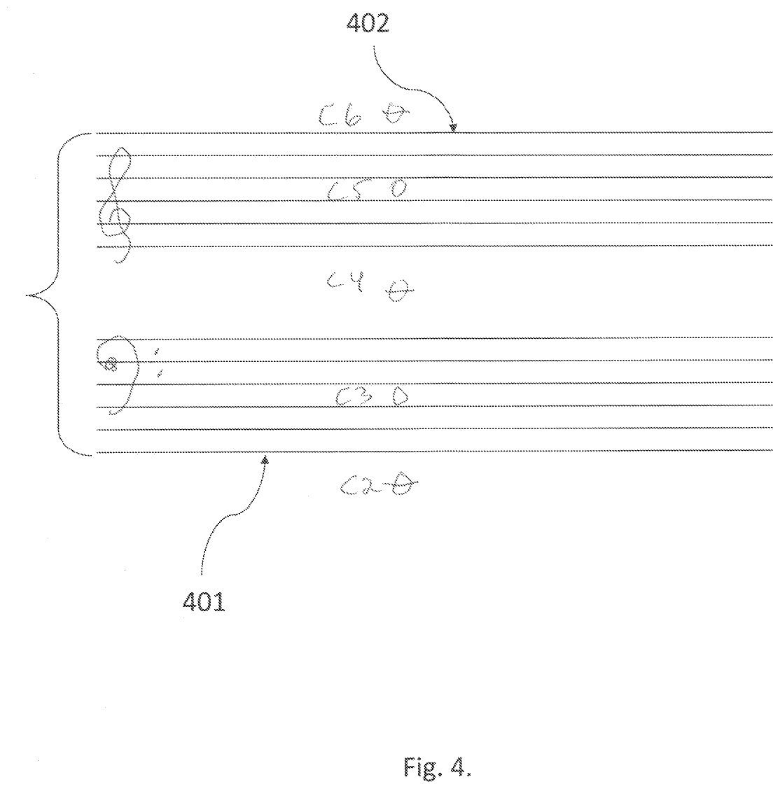

The 6+6 grand staff, (see FIG. 4) adds a sixth line 401 at the bottom of the bass staff and a sixth line 402 at the top of the treble staff of the grand staff. This allows the C4 ledger line to be duplicated two octaves up (C6) and two octaves down (C2). The six lines plus the ledger line adds up to seven lines containing exactly two full scales (each of which has seven named notes). I have reduced the number of different positions for C from five to three, this time no matter whether the lines are counted from top to bottom or bottom to top.

Same named notes in the bass staff are in the same positions as in the treble staff of the new grand staff—there is no two-note shift as in the 5+5 grand staff.

The sixth lines do not have to be drawn the same as the other lines, they can be distinguishable lines to accommodate musicians changing from the 5+5 grand staff to the 6+6 grand staff or vice versa, allowing the sixth lines to be ignored or noticed as convenient.

### Third Embodiment

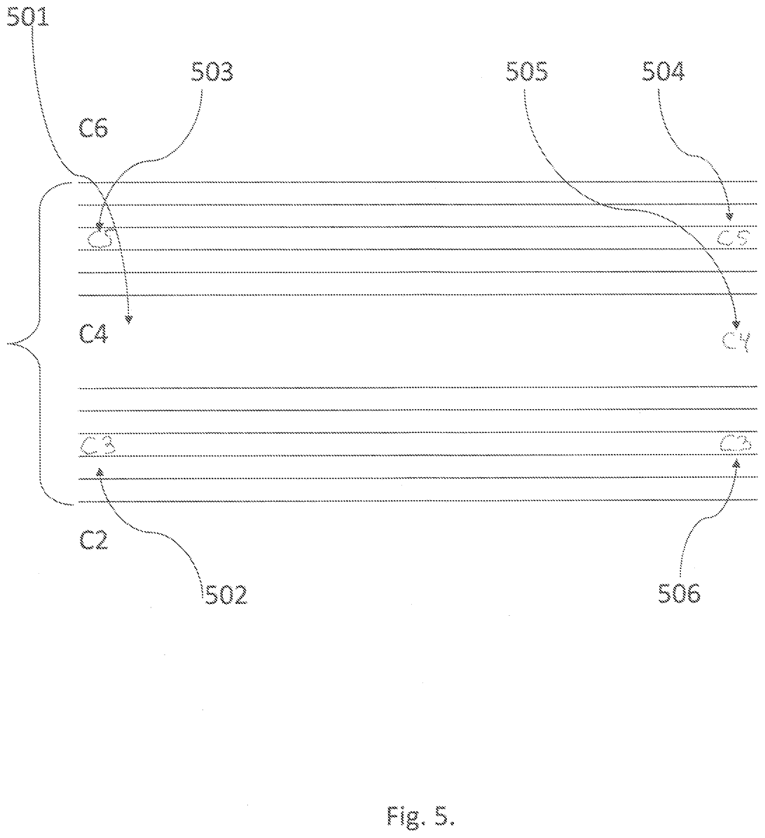

In the continuous grand staff, whether a 5+5 or a 6+6 continuous grand staff, there is only need for one pitch indicator 501 (FIG. 5), not two (such as the two G and F clefs), since the relationship between the two staves is set by continuity. In fact, since the middle position is defined as C4 there is no need for clefs at all, the space between the two staves can function as a clef—the ornateness of the grand staff can be drastically reduced.

Not only could there be fewer pitch indicators (clefs), there could be more. For example, the pitch indicators could be the Cs (for example, just C4 or also C3 and C5 indicated by 502 and 503, respectively). The pitch indicators could also occur on both sides of the staff—the left AND the right side, to make the note reading close to the both sides of the staff a little easier (504, 505 and 506).

Pitch indicators that are standard pitch indicators makes it easy to discuss octaves. If a student is playing the A4 instead of the A3, one can easily tell him that if the pitch indicators are used instead of ornate clefs.

There could also be pitch indicators of the key of the music that is being played.

### Fourth Embodiment

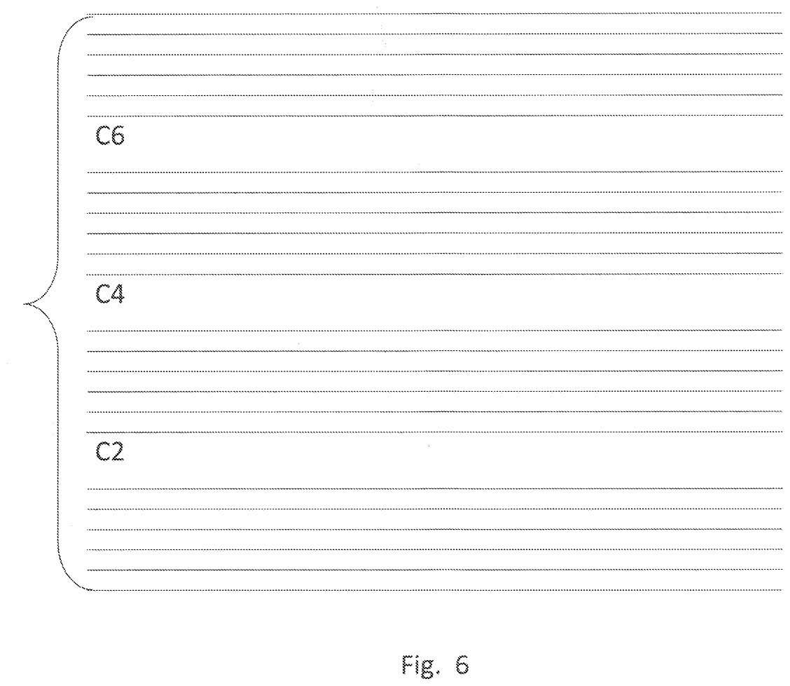

FIG. 6 shows that one can repeat the second embodiment structure up and/or down to create the opportunity to place more notes with a minimal number of ledger lines (the C2, C4 and C6 in between the staves being the exception) and have the same named notes on the same lines.

The placement of the pitch indicators of the third embodiment could be repeated.

If the notes require the repeated staff to be used but not the original staff, the original staff could have an octava line placed above it.

If there is space needed for writing (dynamics, etc.) and there is an empty piece of staff, a part of the staff could be partially erased.

### Fifth Embodiment

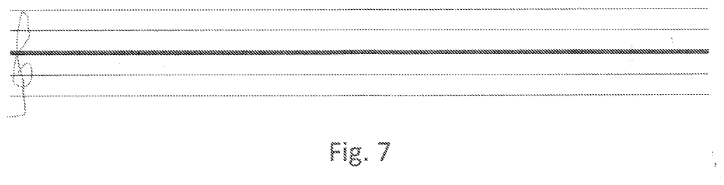

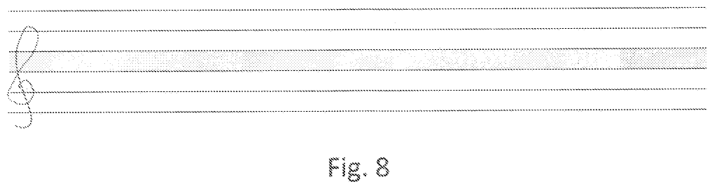

As shown in FIG. 7, one can have distinguishable lines or distinguishable line spaces, to make it easier for the eye to identify the lines, spaces and notes within the staff. While a clef distinguishes the lines of a staff, it is confined to the left hand side and does not have the same visual reach as a distinguishable line or distinguishable line space. If the staff has an odd number of lines, the middle line can be a distinguishable line. If the staff has an even number of lines, the line space between the middle two lines can be a distinguishable line space. One does not have to make the middle line or line space distinguishable, another line or line space can be selected to distinguishable as well.

### Sixth Embodiment

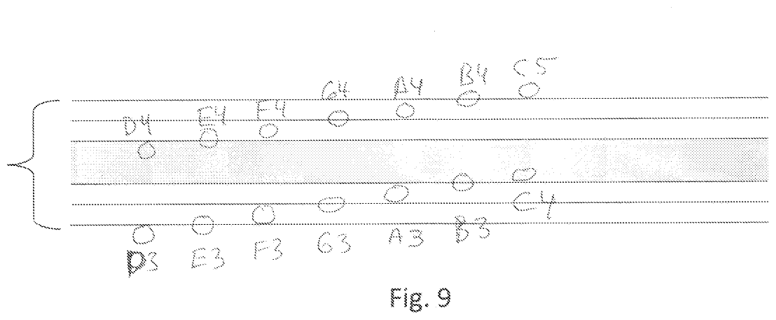

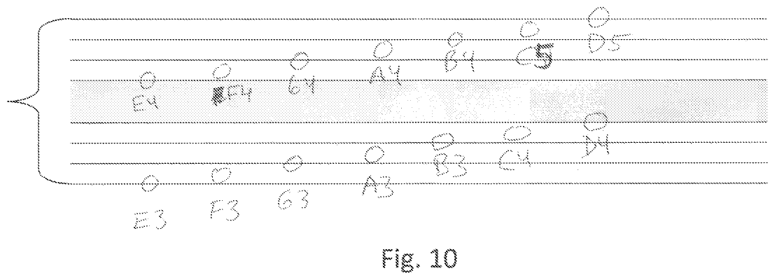

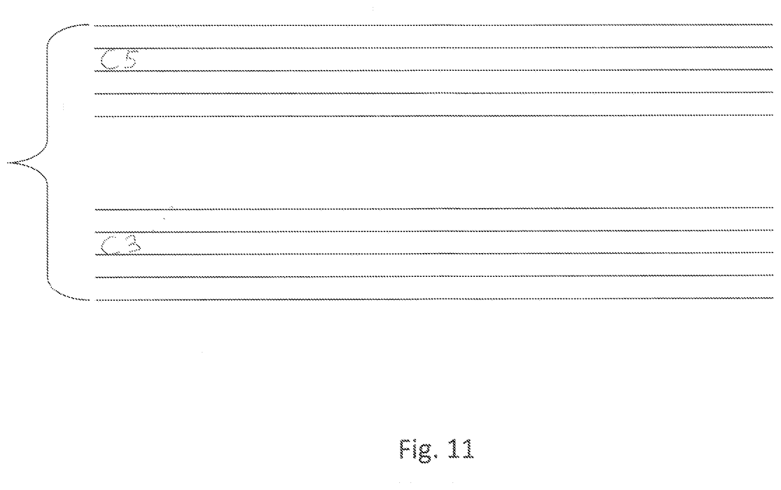

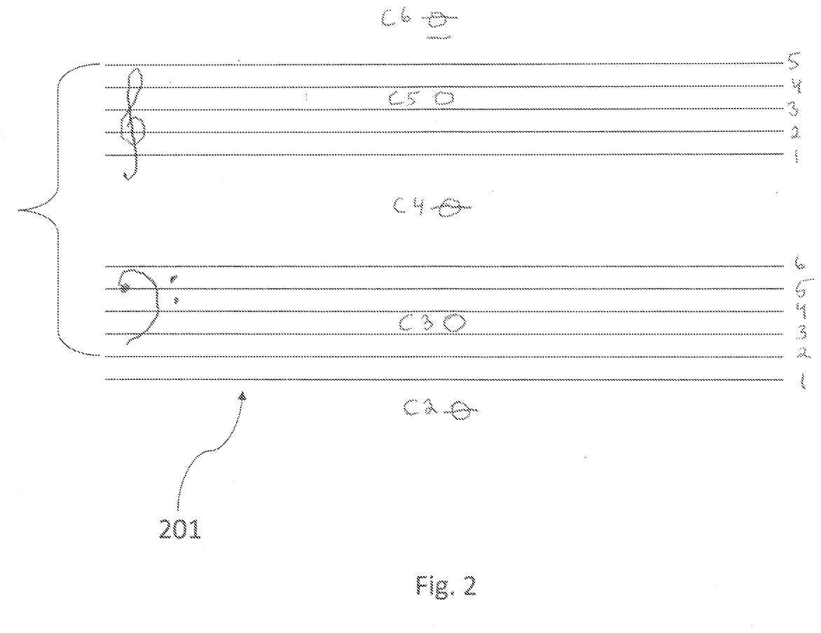

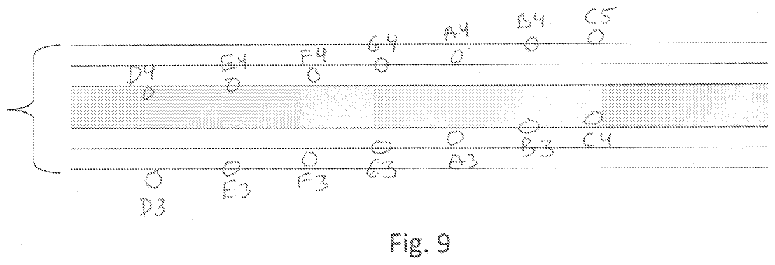

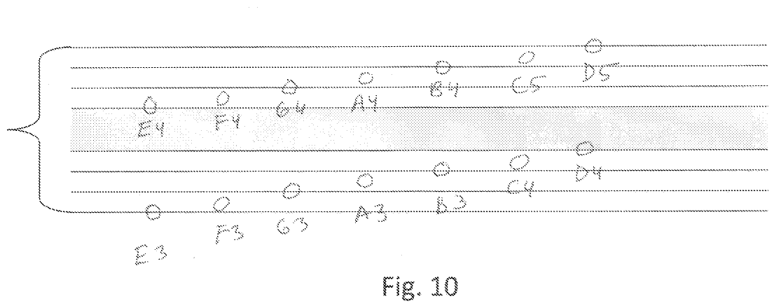

Thus far, C4 and C5 are on a (ledger) line and a line space, respectively. In order for both C4 and C5 to look the same, it is necessary to break up the sequence line-line space-line-line space etc, i.e. break the principle of continuity (which is often broken by the use of ledger lines anyway). Thus a set of three lines, two line spaces and two positions on top and below the bottom of the lines accommodates exactly 7 notes (the order can be, but does not have to be, D3, E3, F3, G3, A3, B3, and C4 in the bass staff and D4, E4, F4, G4, A4, B4, C5 in the treble staff) (FIG. 9). The repetition of a staff allows each octave to look the same. The same can also be accomplished with four lines and three line spaces (in which no notes are allowed above or below the lines and the notes could be, for example, E3, F3, G3, A3, B3, C4 and D4 in the bass staff and E4, F4, G4, A4, B4, C5 and D5 in the treble staff) (FIG. 10). The space between the staves could have a different back ground color and a different width from the line space width.

### Seventh Embodiment

The number of lines in each staff can be flexible. When a beginner learns to read notes the lines in each staff can be displayed one at a time as the student becomes more advanced. The first lines to be displayed could be the bottom line in the treble staff and the top line in the bass staff or it could be the bottom line in the treble staff and the bottom line in the bass staff, etc. This is particularly useful when music is displayed by a computer—the computer can figure out just how many lines are needed for a particular music piece.

### Eighth Embodiment

If we give up on the notion of the middle C, continuity and anti-parallel thinking altogether, then a convenient notation system is one in which no matter how many lines, an E is always on the first line. Rather than having a grand staff with F and G clefs we would have a grand staff with, for example, a C3 and a C5 pitch indicator (or two G or two F clefs for that matter in which it is understood that they denote two different octaves), see FIG. 11.

In broad embodiment, the present invention is a music notation system and method. While the foregoing written description of the invention enables one having ordinary skill to make and use what is considered presently to be the best mode thereof, those having ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

This music notation implement may be formed as a sheet music when the above-mentioned lines, line spaces, and pitch indicators are drawn on a sheet such as a piece of paper, or may be formed as a program that shows such musical score on a display of personal computer or have it printed out by a computer or the like. When printing out music, the embodiments presented in this disclosure can be computer programmed options to utilize for printing and displaying if the customer requests them and to demonstrate the new notation system to increase customer demand.

### CONCLUSIONS, RAMIFICATIONS, SCOPE

According to one or more aspects, my article has one or more of the following advantages:

### FIELD OF THE INVENTION

The present invention is in the technical field of sheet music notation.

G10G 1/02. Chord or note indicators, fixed or adjustable, for keyboard of fingerboards G09B 15/00

Teaching Music

The present invention is in the technical field of music notation and charting. Music notation or charting is any system used to visually represent aurally perceived music through the use of written symbols. Particularly, the present invention is in the technical field of music notation or charting systems that combine enhanced functionality and greater readability for musicians who are not full-time professionals.

What is claimed is:

1. A music notation comprising a diatonic staff of N lines, where N is greater than or equal to two, and at least one member selected from the group consisting of distinguishable line, distinguishable line space, left side pitch indicator and right side pitch indicator.

2. The article of claim 1 in which N=6 and said member is a distinguishable line at a position selected from the group consisting of the bottom of a bass staff and the top of a treble staff.

3. The article of claim 1 in which said member depends upon the key of the music piece.

4. The article of claim 1 in which said member depends upon the tessitura.

5. The article of claim 1 in which N increases with the ability of the musician to read the notation.

6. A music notation comprising:
P diatonic staves with N₁, N₂, . . . N_{P} lines, respectively, where N₁, N₂ . . . N_{P} are integers greater than or equal to 1 and P is an integer greater than or equal to 2;
wherein each staff contains at least one same named note on at least one same position.

7. The article of claim 6 where P=2, N₁=6 and N₂═5 and the 6th line corresponds to a member of the group consisting of distinguished line and line.

8. The article of claim 6 where P=2, N₁=6 and N₂=6.

9. The article of claim 6 where C4 is on a ledger line between at least two of the staves.

10. The article of claim 6 where all N₁, N₂, . . . N_{P}=M where M is a member selected from the group consisting of 3 and 4.

11. The article of claim 10 in which M=3 and ledger lines are not allowed.

12. The article of claim 10 in which M=4; wherein ledger lines and notes below and above the top and bottom lines of each staff are not allowed.

12. The article of claim 6 where the staves display the notes for one musician.

13. The article of claim 12 where the notation is for a keyboard instrument.

14. The article of claim 13 where said keyboard instrument is a piano.

15. The article of claim 6 in which N increases with the ability of the musician to read the notation.

16. A combination of P>0 staves in which the number of lines in each staff N₁, N₂, . . . N_{P} is larger than 0 and is increased as the student ability to read the notation improves.

17. The article of claim 1 implemented with a computer system with program and memory and a member of the group consisting of printing out the music and displaying the music.

18. The article of claim 6 implemented with a computer system with program and memory and a member of the group consisting of printing out the music and displaying the music.

19. The article of claim 16 implemented with a computer system with program and memory and a member of the group consisting of printing out the music and displaying the music.
